(19) United States
(12) Patent Application Publication
(10) Pub. No.: US 2016/0226623 A1
(43) Pub. Date: Aug. 4, 2016

(54) Network Node, User Equipment and Methods for Obtaining a Modulation and Coding Scheme

(71) Applicant: TELEFONAKTIEBOLAGET L M ERICSSON (PUBL), Stockholm (SE)

(72) Inventors: Jonas Fröberg Olsson, Ljungsbro (SE); Erik Eriksson, Linköping (SE); Arne Simonsson, Gammelstad (SE)

(21) Appl. No.: 15/021,139

(22) PCT Filed: Sep. 20, 2013
(86) PCT No.: PCT/SE2013/051103

§ 371 Date: Mar. 10, 2016

(51) Int. Cl. H04L 1/00; H04L 25/02; H04B 7/06; H04L 12/801; H04L 1/18

(52) U.S. Cl. CPC H04L 1/0023; H04L 47/12; H04L 1/1812; H04B 7/0626; H04B 7/0632; H04L 25/0202

(57) ABSTRACT

A method in a user equipment for obtaining a Modulation and Coding Scheme, MCS is provided. The MCS is to be used for a transmission between the user equipment and any one or more out of the network node or a second network node. The user equipment has knowledge about a modulation and coding index table. The user equipment receives (201) one or more offset values from the network node. The user equipment obtains (205) an MCS indicator related to said transmission. The user equipment then obtains (206) the MCS from the modulation and coding index table based on the MCS indicator and the one or more offset values.

### TECHNICAL FIELD

Embodiments herein relate to a user equipment, a network node and methods therein. In particular, it relates to obtaining a Modulation and Coding Scheme, MCS, which MCS.

### BACKGROUND

Communication devices such as User Equipments (UEs) are enabled to communicate wirelessly in a cellular communications network or wireless communication system, sometimes also referred to as a cellular radio system or cellular networks. The communication may be performed e.g. between two UEs, between a UE and a regular telephone and/or between a UE and a server via a Radio Access Network (RAN) and possibly one or more core networks, comprised within the cellular communications network.

UEs may further be referred to as wireless terminals, wireless device, mobile terminals and/or mobile stations, mobile telephones, cellular telephones, laptops, tablet computers or surf plates with wireless capability, just to mention some further examples. The UEs in the present context may be, for example, portable, pocket-storable, hand-held, computer-comprised, or vehicle-mounted mobile devices, enabled to communicate voice and/or data, via the RAN, with another entity, such as another user equipment or a server. The UE may also be a machine to machine communication device that serves as a data communication modem or is built in to equipment communicating data with server without human interaction.

The cellular communications network covers a geographical area which is divided into cell areas, wherein each cell area being served by an access node. A cell is the geographical area where radio coverage is provided by the access node.

The access node may further control several transmission points, e.g. having Remote Radio Units (RRUs). A cell can thus comprise one or more access nodes each controlling one or more transmission/reception points. A transmission point, also referred to as a transmission/reception point, is an entity that transmits and/or receives radio signals. The entity has a position in space, e.g. an antenna. An access node is an entity that controls one or more transmission points. The access node may e.g. be a base station such as a Radio Base Station (RBS), enhanced Node B (eNB), eNodeB, NodeB, B node, or BTS (Base Transceiver Station), depending on the technology and terminology used. The base stations may be of different classes such as e.g. macro eNodeB, micro eNodeB, home eNodeB or pico base station, based on transmission power and thereby also cell size.

Further, each access node may support one or several communication technologies. The access nodes communicate over the air interface operating on radio frequencies with the UEs within range of the access node. In the context of this disclosure, the expression Downlink (DL) is used for the transmission path from the base station to the mobile station. The expression Uplink (UL) is used for the transmission path in the opposite direction i.e. from the UE to the base station.

In 3rd Generation Partnership Project (3GPP) Long Term Evolution (LTE), base stations, which may be referred to as eNodeBs or even eNBs, may be directly connected to one or more core networks.

3GPP LTE radio access standard has been written in order to support high bitrates and low latency both for uplink and downlink traffic. All data transmission is in LTE is controlled by the radio base station.

In LTE, Channel State Information (CSI) is collected by a base station and used to adopt the transmission for each UE in the cell. CSI is a report format including one or more suggestions by the UE for transmission rank, pre-coding and/or modulation and coding reflecting one or more CSI measurement instances. A CSI process may define such a CSI measurement instance specifying the channel and interference measurement resource. The transmission adaption is known as link adaptation wherein a transmission rank, pre-coder and Modulation and Coding Scheme (MCS) is selected.

In many mobile communication systems the selected MCS is signaled from a base station to a UE using a single indicator.

In 3GPP specified systems such as TS 36.213, Section 7.1.7.1 for DL and Section 8.6.1 for UL and this indicator is known as the MCS Index, or MCSI, and is sent on a Physical Downlink Control CHannel (PDCCH) or evolved PDCCH (ePDCCH). Herein, an “indicator” will be referred to as what is signaled and “index” will be referred to as a table entry.

In LTE (Long-Term Evolution) the MCS indicator comprises of 5-bits that give 32 different values ranging from 0 to 31. Using 5 bits, 2″5=32 different binary values can represented: 0=(0,0,0,0,0), 1=(0,0,0,0,1), 2=(0,0,0,1,0), . . . , 31=(1,1,1,1,1). The values 29-31 are reserved for re-transmissions and hence the values 0-28 remain to indicate different modulations and code rates (coding scheme) for new transmissions. For downlink the MCS indicator maps to a MCS index providing to a Transport Block Size (TBS) index, (I_{TBS}) using Table 1, see 3GPP TS 36.213, Section 7.1.7.1 Physical layer procedures. Thus, in the terminology used herein, MCS_index=MCS_indicator.

TABLE 1
Modulation and TBS index table PDSCH

| MCS Index | Modulation Order | TBS Index |
|---|---|---|
| I_{MCS} | Qₘ | I_{TBS} |
| 0 | 2 | 0 |
| 1 | 2 | 1 |
| 2 | 2 | 2 |
| 3 | 2 | 3 |
| 4 | 2 | 4 |
| 5 | 2 | 5 |
| 6 | 2 | 6 |
| 7 | 2 | 7 |
| 8 | 2 | 8 |
| 9 | 2 | 9 |
| 10 | 4 | 9 |
| 11 | 4 | 10 |
| 12 | 4 | 11 |
| 13 | 4 | 12 |
| 14 | 4 | 13 |
| 15 | 4 | 14 |
| 16 | 4 | 15 |
| 17 | 6 | 15 |
| 18 | 6 | 16 |
| 19 | 6 | 17 |
| 20 | 6 | 18 |
| 21 | 6 | 19 |
| 22 | 6 | 20 |
| 23 | 6 | 21 |
| 24 | 6 | 22 |
| 25 | 6 | 23 |
| 26 | 6 | 24 |
| 27 | 6 | 25 |
| 28 | 6 | 26 |
| 29 | 2 | reserved |
| 30 | 4 | |
| 31 | 6 | |

Modulation order (Qₘ) 2 means Quadrature Phase-Shift Keying (QPSK), modulation order 4 means 16 Quadrature Amplitude Modulation 16(QAM), and modulation order 6 means 64 QAM modulation. Up to Release 11 of the 3GPP specification higher modulation than 64 QAM is not supported. Now 3GPP started to discuss extending the support to 256 QAM.

In QAM, an input stream is divided into groups of bits based on the number of modulation states used. For example, in QPSK, each two bits of input, provides four values alters of the phase and amplitude of the carrier to derive four unique modulation states. In 16 QAM and 64 QAM four and six bits generate 16 and 64 modulation states respectively.

A straight-forward extension to 256 QAM support may increase the number of bits for the MCS indicator/index or reduce the TBS resolution for QPSK, 16 QAM and 64 QAM to make room for 256 QAM TBS entries.

Also CQI reporting needs a corresponding extension to support 256 QAM. The existing reporting format only supports up to an efficiency of 5.5547 which will not give room to report a channel quality where 256 QAM is beneficial. Simply described, efficiency refers to the number of information bits per modulation symbol that is supported by the channel to achieve 10% error rate. CQI is precisely defined in 3GPP TS 36.213, Section 7.2.3 See Table 2 from 3GPP TS 36.213, Section 7.2.3 . . . .

TABLE 2
CQI table

| CQI index | modulation | code rate × 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

The CQI indices define different modulation and coding schemes for a imagined PDSCH transmission on a so-called CSI reference resource, wherein the CSI reference resource specifies a group of physical resource blocks and their physical layer properties. The CSI reference resource specifies when the transmission was imagined to occur, which resources were used, and so on. The CSI reference resource thus specifies how UE shall measure and how it shall derive a CQI value from list of CSI indices.

The CQI comprises information sent from a UE to a base station to indicate a suitable transmission adaptation, i.e., the CQI value is an MCS value. CQI is a 4-bit integer and is based on the observed Signal-to-Interference-plus-Noise Ratio (SINR) at the UE. The CQI estimation process takes into account the UE capability such as the number of antennas and the type of receiver used for detection. This is important since for the same SINR value the MCS level that can be supported by a UE depends on these various UE capabilities, which needs to be taken into account in order for the base station to select an optimum MCS level for a transmission. The CQI reported values are used by the base station for downlink scheduling and link adaptation.

Similar straight forward extensions as for MCS may be applied, to increase the number of bits for CQI reporting or to reduce the efficiency and coder rate resolution.

There are problems with the above solutions since they lead to new Downlink Control Information (DCI) and Channel Status Information (CSI) formats and increased signaling overhead and to worse performance since possible TBS is further away from the optimal one and further to worse channel estimation for link adaptation since the CSI refinement is reduced.

### SUMMARY

It is therefore an object of embodiments herein to enhance the performance in a wireless communications network.

According to a first aspect of embodiments herein, the object is achieved by a method in a user equipment for obtaining a Modulation and Coding Scheme, MCS. The MCS is to be used for a transmission between the user equipment and any one or more out of the network node or a second network node. The user equipment has knowledge about a modulation and coding index table. The user equipment receives one or more offset values from the network node. The user equipment obtains an MCS indicator related to said transmission. The user equipment then obtains the MCS from the modulation and coding index table based on the MCS indicator and the one or more offset values.

According to a second aspect of embodiments herein, the object is achieved by a method in a network node for assisting a user equipment to obtain a Modulation and Coding Scheme, MCS. The MCS is to be used for a transmission between the user equipment and any one or more out of the network node or a second network node. The network node defines one or more offset values for the user equipment. The defined one or more offset values are related to a modulation and coding index table. The network node then sends the defined one or more offset values to the user equipment. The one or more offset values enable the user equipment to obtain the MCS from the modulation and coding index table.

According to a third aspect of embodiments herein, the object is achieved by a user equipment for obtaining a Modulation and Coding Scheme, MCS. The MCS is to be used for a transmission between the user equipment and any one or more out of the network node or a second network node. The user equipment has knowledge about a modulation and coding index table. The user equipment comprises a receiving circuit configured to receive one or more offset values from the network node. The user equipment further comprises an obtaining circuit configured to obtain an MCS indicator related to said transmission. The obtaining circuit is further configured to obtain the MCS from the modulation and coding index table based on the MCS indicator and the one or more offset values.

According to a fourth aspect of embodiments herein, the object is achieved by a network node for assisting a user equipment to obtain a Modulation and Coding Scheme, MCS, which MCS is to be used for a transmission between the user equipment and any one or more out of the network node or a second network node. The network node comprises a defining circuit configured to define one or more offset values for the user equipment. The defined one or more offset values are related to a modulation and coding index table. The network node further comprises a sending circuit configured to send the defined one or more offset values to the user equipment. The one or more offset values enable the user equipment to obtain the MCS from the modulation and coding index table.

By using the one or more offset values when the user equipment can obtain the MCS from the modulation and coding index table enabling the modulation and coding index table to be extended with more entries where the addressed row may be determined by a combination of a MCS indicator in the legacy format, and one or more offset values. This provides modulation and coding index table signalling for higher order modulation such as e.g. 256 QAM at low signalling cost resulting in an enhanced performance of the wireless communications network.

A further advantage with embodiments herein is that no new DCI or CSI formats are required to be defined in the standard, and can thus operate in full backward compatible manner.

An advantage with embodiments herein is also that the MCS resolution is increased at low signaling cost.

### BRIEF DESCRIPTION OF THE DRAWINGS

Examples of embodiments herein are described in more detail with reference to attached drawings in which:

FIG. 1 is a schematic block diagram illustrating embodiments of a wireless communications network.

FIG. 2 is a flowchart depicting embodiments of a method in a user equipment.

FIG. 3 is a flowchart depicting embodiments of a method in a network node

FIG. 4 is a schematic block diagram illustrating embodiments of a user equipment.

FIG. 5 is a schematic block diagram illustrating embodiments of a network node.

### DETAILED DESCRIPTION

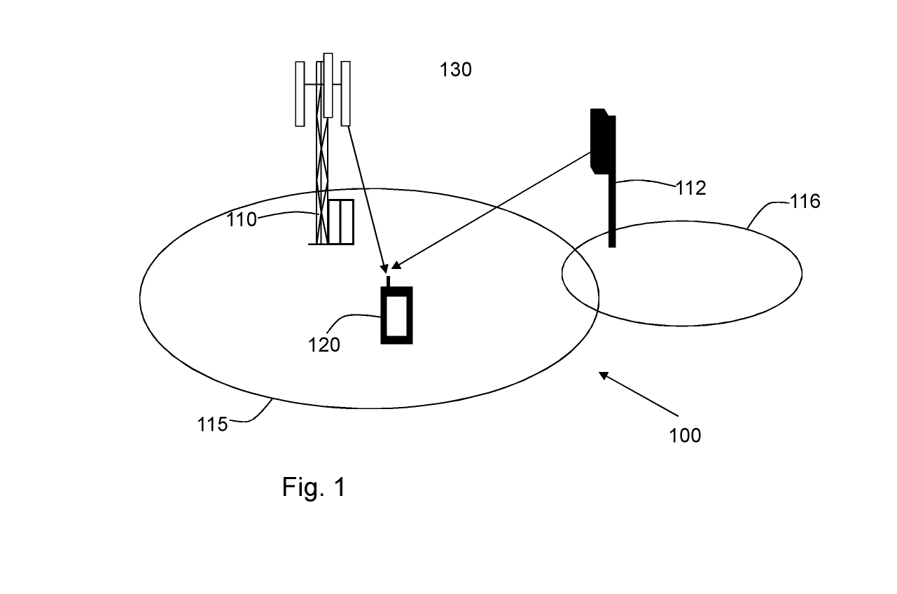

FIG. 1 depicts an example of a wireless communications network 100 according to a first scenario in which embodiments herein may be implemented. The wireless communications network 100 is a wireless communication network such as an LTE, WCDMA, GSM network, any 3GPP cellular network, Wimax, or any cellular network or system.

The wireless communications network 100 comprises plurality of network nodes whereof two, a network node 110 and a second network node 112 are depicted in FIG. 1. The term second network node 112 used herein may in some embodiments relate to one or more second network nodes 112. The network node 110 and the second network node 112 are network nodes which each may be a transmission point such as a radio base station, for example an eNB, an eNodeB, or an Home Node B, an Home eNode B or any other network node capable to serve a user equipment or a machine type communication device in a wireless communications network. The network node 110 serves a first cell 115 and the second network node 112 serves a second cell 116. In another exemplifying wireless network the second network node 112 serves the same first cell 115, wherein the second cell 116 is not present, or the second cell 116 may be part of the coverage area for first cell 115.

A user equipment 120 is configured to operate in the wireless communications network 100. The network node 110 and the second access node 112 may each be a transmission point for the user equipment 120. However, embodiments herein may be applied in any kind of network scenario where the user equipment 120 and the network node 110 collaborate as e.g. in LTE.

The user equipment 120 may e.g. be a wireless device, a mobile wireless terminal or a wireless terminal, a mobile phone, a computer such as e.g. a laptop, a Personal Digital Assistants (PDAs) or a tablet computer, sometimes referred to as a surf plate with wireless capability, or any other radio network units capable to communicate over a radio link in a wireless communications network. Please note the term user equipment used in this document also covers other wireless devices such as Machine to machine (M2M) devices.

According to some embodiments herein, one or more offset values are defined. MCS and CQI tables are extended with more entries where the addressed row may be determined by a combination of signaled indicator in the legacy format, such as e.g. TBS and CQI respectively, and one or more offset values. For example, if the MSC indicator is 24, and the offset value is defined to be 6, the modulation and coding index table shall be entered at MCS index 24+6=30. In another example, if the MSC indicator is 24, and the offset value is defined to be 0, the modulation and coding index table shall be entered at MCS index 24+0=24.

The one or more offset values may preferably be signaled to the user equipment 120 using Radio Resource Control (RRC) signaling. The offset value may be common or separate for MCS and CQI as well as same or individual for each rank. This provides MCS signalling for higher order modulation, such as e.g. 256 QAM at low signalling cost. In general, an offset value defines a mapping from an MCS indicator to an MCS index value. One such mapping is exemplified by the function

MCS_index=MCS_indicator+MCS_offset, [1]

where MCS_indicator is the MCS indicator and MCS_offset is the offset value.

Another example with two offset values MCS_offset#1 and MCS_offset#2 representing the MCS subset selector may be defined by the function

MCS_index=A(MCS_offset#1)*MCS_indicator+B(MCS_offset#2),

where A(MCS_offset#1) and B(MCS_offset#2) are values determined by the offset values.

Embodiments of a method will first be described seen from a perspective of the user equipment 120, and after embodiments of the method will be described seen from a perspective of the network nod 110. These are first described in a general way. Embodiments of the methods will then be described more in detail.

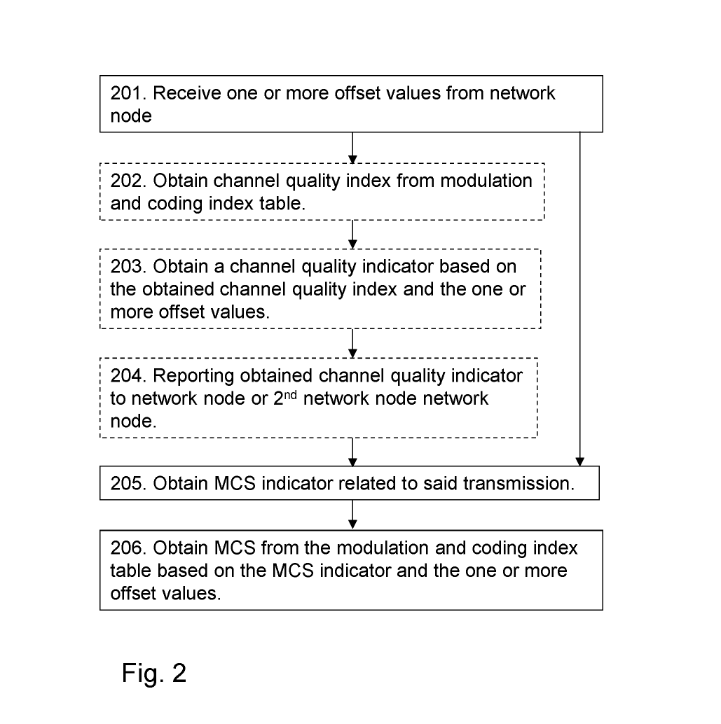

Example of embodiments of a method in the user equipment 120 for obtaining a MCS, will now be described with reference to a flowchart depicted in FIG. 2. The MCS is to be used for a transmission between the user equipment 120 and any one or more out of the network node 110 or a second network node 112. As mentioned above, the term second network node 112 used herein may in some embodiments relate to one or more second network nodes 112, since several network nodes may be involved in the transmission. The, user equipment 120 has knowledge about a modulation and coding index table. The method comprises the following actions, which actions may be taken in any suitable order. Dashed lines of one box in FIG. 2 indicate that this action is not mandatory.

Action 201

The user equipment 120 receives one or more offset values from the network node 110.

The one or more offset values are preferably sent less frequently than the transmission frequency for the MCS indicator. A new offset is preferable sent to the user equipment 120 when the used MCS indicator is close to maximum or minimum value. A new offset is preferable sent when a new dynamic range determined by the MCS indicator and offset value is predicted to be beneficial. For example, when the user equipment 120 is close to the network node 110 an offset value that enable selection of high MCS indices is to prefer while an offset value that enable selection of lower MCS indices is to prefer when the user equipment 120 is further away from the network node 110. In some cases where the user equipment is moving at high speed, a new updated one or more offset values may be sent every second or even every 100 ms. While in other cases where the user equipment 120 is stationary during each communication session it is only sent once during the session start up and no update is needed.

The offset value when used for MCS may be referred to as a MCS offset value herein. The user equipment 120 may receive the offset value such as e.g. an MCS offset value from the network node 110. The MCS offset value may be defined by the network node 110 based on the position and signal quality of the user equipment 120. A new updated MCS offset value may be sent to the user equipment 120 when the position and/or signal quality of the user equipment 120 have changed. E.g. assuming an offset value represented by the formula [1] and an MCS index table extended with 256 QAM MCS indices e.g. 29-33, see Table 3, the network node 110 may establish that the user equipment 120 is in such good radio condition that it can cope with transmission using MCS higher than 64 QAM, e.g. 256 QAM and in that case send a MCS offset value above zero. Or the opposite scenario, wherein the network node 100 may establish that the user equipment 120 is not in such good radio condition that it can cope with transmission using MCS higher than 64 QAM, e.g. 256 QAM and in that case send a MCS offset value that is zero.

The one or more offset values may be represented by one or more MCS subset selectors from the modulation and coding index table.

In some embodiments the one or more offset values comprises multiple offset values. In these embodiments the respective offset value out of the multiple offset values may be associated with one or more out of: a rank, a quasi co-location, a downlink control information format, a Downlink control information resource such as e.g. associated with a respective EPDCCH- Physical Resource Block (PRB) set, a user equipment search space sets for a Physical Downlink Control Channel, PDCCH, or evolved PDCCH, EPDCCH, and a transmission mode.

Action 202

To be able to obtain a channel quality indicator, which may be referred to as CQI, the user equipment 120 may first obtain a channel quality index from a modulation and coding index table. How this is performed will be further described below. This table may in some embodiments be different from the modulation and coding index table mentioned below in Action 206.

Action 203

The user equipment 120 may then obtain the channel quality indicator based on the obtained channel quality index and the one or more offset values. How this is performed will also be further described and exemplified below.

Action 204

In some embodiments, the user equipment 120 reports the obtained channel quality indicator to any one or more out of: the network node 110 or the second network node network node 112. The channel quality indicator together with the offset value maps to a channel quality index in a first modulation and coding index table that the network node 110 use to select a potentially different modulation and coding index in the first or the second modulation and coding index table.

Action 205

To be able to obtain the MCS indicator related to said transmission the user equipment 120 will use an MCS indicator related to said transmission together with the one or more offset values. Thus, the user equipment 120 obtains an MCS indicator related to said transmission. This may for example be a scheduling comprising the MCS indicator, sent to the user equipment 120 when the transmission is to be started.

In LTE DL the MCS indicator is either sent prior to the transmission using PDCCH for transmitting the MCS indicator or simultaneously as the transmission using evolved PDCCH for transmitting the MCS indicator. Here user equipment may have to buffer the transmission also in theory before being able to obtain the MCS indicator. For LTE UL the MCS indicator is sent prior to the transmission for both cases for transmission of the MCS indicator.

In some embodiments, the MSC indicator is obtained by being received from the network node involved in the transmission. The network node involved in the transmission may be any one or more out of: the network node 110 or the second network node network node 112.

Action 206

In this Action, the user equipment 120 obtains the MCS from the modulation and coding index table based on the MCS indicator and the one or more offset values.

See the example as mentioned above, i.e., the offset value represented by the formula [1], if the MSC indicator is 24, and the offset value is 6, the modulation and coding index table shall be entered at MCS index value 24+6=30 to find the MSC index. In another example, if the MSC indicator is 24, and the offset value is 0, the modulation and coding index table shall be entered at MCS index value 24+0=24 to find the MSC index. How this is performed will also be further described and exemplified below.

After Action 206 the user equipment 120 is able to determine the transport block size, based on the obtained MCS index, which was used in DL or which shall be used in UL in the transmission. For DL, the transport block size is then used to decode the transmission while for UL the transport block size is used when to encode the transmission.

Embodiments of the method will now be described seen from a perspective of the network nod 110.

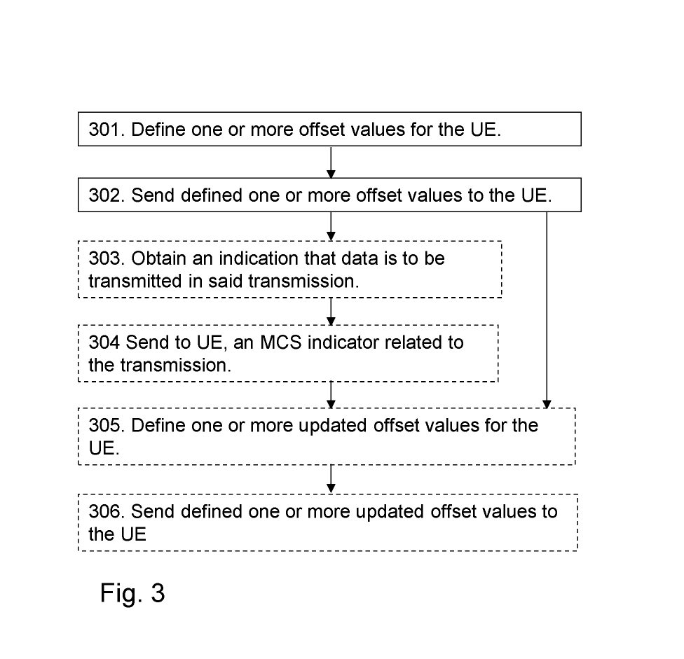

Thus, example of embodiments of a method in the network node 110 for assisting a user equipment 120 to obtain a MCS will now be described with reference to a flowchart depicted in FIG. 3. As mentioned above, the MCS is to be used for a transmission between the user equipment 120 and any one or more out of the network node 110 or the second network node 112.

The method comprises the following actions, which actions may be taken in any suitable order. Dashed lines of one box in FIG. 3 indicate that this action is not mandatory.

Action 301

In this Action, the network node 110 defines the one or more offset values for the user equipment 120. The defined one or more offset values are related to a modulation and coding index table. The one or more offset values are preferably sent less frequently than the transmission frequency for the MCS indicator. A new offset is preferable sent to the user equipment 120 when the used MCS indicator is close to maximum or minimum value. A new offset is preferable sent when a new dynamic range determined by the MCS indicator and offset value is predicted to be beneficial. For example, when the user equipment 120 is close to the network node 110 or second network node 112, an offset value that enable selection of high MCS indices is to prefer while an offset value that enable selection of lower MCS indices is to prefer when the user equipment 120 is further away from the network node 110 or second network node 112.

The one or more offset values may be defined by the network node 110 based on the position and signal quality of the user equipment 120. A new updated offset value may be sent to the user equipment 120 when the position and/or signal quality of the user equipment 120 have changed, see Action 305.

E.g. as mentioned above, the network node 100 may establish that the user equipment 120 is in such good radio condition that it can cope with transmission using MCS higher than 64 QAM, e.g. 256 QAM and in that case define an offset value above zero. Or the opposite scenario, wherein the network node 100 may establish that the user equipment 120 is not in such good radio condition that it can cope with transmission using MCS higher than 64 QAM, e.g. 256 QAM and in that case define an offset value that is zero. See again the example as mentioned above, if the MSC indicator is 24, and the offset value is defined to 6, the modulation and coding index table shall be entered at MCS index value 24+6=30. In another example, if the MSC indicator is 24, and the offset value is defined to 0, the modulation and coding index table shall be entered at MCS index value 24+0=24. How this is performed will also be further described and exemplified below.

The one or more offset values may be represented by one or more MCS subset selectors from the modulation and coding index table. This will be described more in detail below.

In some embodiments, the one or more offset values comprise multiple offset values. In these embodiments the respective offset value out of the multiple offset values may be associated with one or more out of: a rank, a quasi co-location, a downlink control information format, a Downlink control information resource-/description: e.g. associated with a respective ePDCCH-PRB set, a user equipment search space sets for a Physical Downlink Control Channel, PDCCH, or evolved PDCCH, (EPDCCH), and a transmission mode.

In some embodiments, wherein the defining 301 the one or more offset values for the user equipment 120, is performed based on historical values from at least one out of: a transmitted MCS or rank, a received Channel Status Information, CSI, a Reference Signal Received Power (RSRP) or a Reference Signal, Received Quality (RSRQ), and a Hybrid Automatic Repeat Request, (HARQ), retransmission.

This action will be described more in detail below.

Action 302

To inform the user equipment about the one or more offset values to use for obtaining MCS, the network node 110 sends the defined one or more offset values to the user equipment 120. The one or more offset values enable the user equipment 120 to obtain the MCS from the modulation and coding index table. Please note that the selected MCS may be different from the MCS obtained by the user equipment.

As mentioned above, the one or more offset values are preferably sent less frequently than the transmission frequency for the MCS indicator. A new offset is preferable sent to the user equipment 120 when the used MCS indicator is close to maximum or minimum value. A new offset is preferable sent when a new dynamic range determined by the MCS indicator and offset value is predicted to be beneficial. For example, when the user equipment 120 is close to the network node an offset value that enable selection of high MCS indices is to prefer while an offset value that enable selection of lower MCS indices is to prefer when the user equipment is further away from the base station.

Action 303

In some embodiments, said transmission is between the user equipment 120 and the network node 110. In these embodiments, the network node 110 may obtain an indication that data is to be transmitted in said transmission. The indication that data is to be transmitted may typically be determined and indicated by a transmission scheduler such as a transmission scheduler. For DL this is when there is data in a buffer to be sent to the user equipment 120. For UL this is when a scheduling request is received from the user equipment 120 or when a buffer status report has been received from the user equipment 120 with information about amount of uplink data to be received.

In some embodiments the network node 110 receives a CSI report from the user equipment 120 which report comprises a CQI indicator. The network node 110 may then obtain a CQI index into the CQI table from said CQI indicator together with the one or the offset values. This means that the network node 110 may receive a CSI report from the user equipment 120 with a CQI indicator. From this CQI indicator together with one or the offset values defined in action 301, a CQI index into the CQI table is obtained. This may be performed in a similar way as in Action 202 and 203. This CQI index may be used to select MCS index for downlink transmissions, see action 304.

Action 304

In the embodiments where Action 303 is performed, the network node 110 may sends to the user equipment 120, an MCS indicator related to the transmission. The MCS indicator may be received by the user equipment in Action 205 described above. The MCS indicator may be selected based on the one and more offset values and a CQI reported by the user equipment 120. The reported CQI may provide a suggested MCS for an imagined PDSCH transmission on a so-called CSI reference resource. The network node then selects the MCS indicator suitable for the resources used for the transmission based on the suggested MCS and the one and more offset values.

Action 305

In some embodiments, the network node 110 defines one or more updated offset values for the user equipment 120 based on channel quality. For example, it may be based on when selected MCS indicator is above or below a certain thresholds or, for a CQI embodiment, when reported channel quality indicator is above or below certain thresholds.

Action 306

In some embodiments, the network node 110 sends the defined one or more updated offset values to the user equipment 120, which one or more offset values enables the user equipment 120 to obtain an updated MCS from the modulation and coding index table.

The text below relates to any suitable embodiment above.

Extending the MCS table

This relates to Action 205, 206 and 301. According to some embodiments herein a modulation and coding index table such as an MCS table is extended. One possible extension of the MCS table is shown in Table 3. Entries with white fill correspond to legacy entries where entries with black fill are added for 256 QAM.

TABLE 3
Extended DL MCS table.

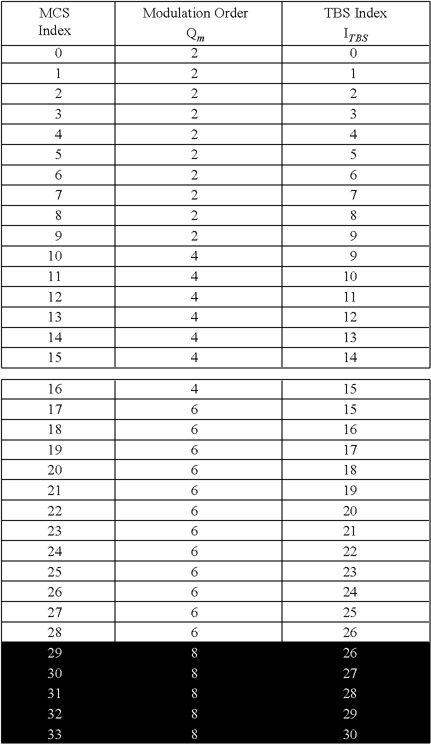

White entries correspond to legacy entries, where black entries are added for 256QAM

In Table 3 the first column is not the MCS indicator carried by PDCCH/ePDCCH but rather a MCS index value, referred to as MSC herein, that is mapped to TBS index. In legacy LTE, there is no distinction between “indicator” and “index”, but here “index” is referred to what defines a table and “indicator” refers to what is signaled. The MCS may be obtained using the MCS_indicator, e.g. carried by a grant on PDCCH/ePDCCH, and the one or more offset values such as e.g. a MCS_offset which may be provided to the user equipment 120 from the network node 110 using RRC signaling as:

MCS=MCS_indicator+MCS_offset.

If MCS_offset=0, 256 QAM becomes disabled. If MCS_offset>0, then 256 QAM is enabled.

Note that with MCS_offset=0, the MCS value, i.e. the MSC equals the MCS_indicator and normal up-to Release 11 of 3GPP TS 36.213 Section 7.1.7.1 operation is obtained, except for the MCS indicator values 29-31 that are used for re-transmissions. For example, a re-transmission of a transport block typically occurs when the network node 110 receives an indication that the user equipment 120 failed to decode a transmission of the transport block. When the network node 110 re-transmits the transport block it may change the modulation, the physical resource blocks used, and the encoding properties. The legacy MCS indicator values 29-31 is to indicate to the user equipment 120 different modulation while maintaining same transport block size. Since legacy supports three modulations QPSK, 16 QAM, 64 QAM, three different MCS indicator values are needed to indicate the modulation used for the re-transmission.

It is possible that MCS index 28 and even 27 will also employ 256 QAM instead of 64 QAM for a user equipment such as the user equipment 120 configured to support 256 QAM. Modulation order would then be determined according to min(Q_m, Q_max) where Q_max is the highest order of modulation supported by the user equipment for this transmission.

To obtain full backward compatibility also for re-transmission MCS, the MCS indicator values [29 min{MCS_offset,1}, 31] may be reserved for re-transmissions. With MCS_offset=0 (legacy), [29, 31] are used for retransmissions. With MCS_offset>0 (256 QAM enabled), [28, 31] are used for transmissions.

With an extended MCS table according to embodiments herein, and MCS_offset=0, this provides full backward compatibility since the MCS indicator values [29 min(0,1), 31]=[29, 31] are reserved for re-transmissions as

MCS_indicator=29 corresponds to: Modulation order Q_m=2, i.e. QPSK modulation.

MCS_indicator=30 corresponds to: Modulation order Q_m=4, i.e. 16 QAM modulation.

MCS_indicator=31 corresponds to: Modulation order Q_m=6, i.e. 64 QAM modulation.

Thus, with MCS_offset=0 the MCS indicator and Table 3 fully coincide with the legacy Table 1.

However, if MCS_offset>0, then e.g.

MCS_indicator=28 corresponds to Modulation order Q_m=2, i.e. QPSK modulation.

MCS_indicator=29 corresponds to: Modulation order Q_m=4, i.e. 16 QAM modulation.

MCS_indicator=30 corresponds to: Modulation order Q_m=6, i.e. 64 QAM modulation.

MCS_indicator=31 corresponds to: Modulation order Q_m=8, i.e. 256 QAM modulation

Thus with e.g. MCS_offset=6 the range for the MCS indicator for new transmissions is [0,27] as follows

$$MCS\_indicator = 0 \text{:} Specify index 6 + 0 = 6 in Table 3.$$

$$MCS\_indicator = 1 \text{:} Specify index 6 + 1 = 7 in Table 3.$$

$$…$$

$$MCS\_indicator = 22 \text{:} Specify index 6 + 22 = 28 in Table 3.$$

$$MCS\_indicator = 23 \text{:} Specify index 6 + 23 = 29 in Table 3 , \\ i . e . 256 Q A M$$

$$…$$

$$MCS\_indicator = 27 \text{:} Specify index 6 + 27 = 33 in Table 3 , \\ i . e . 256 Q A M \\ Hence , the preferable range for the MCS\_offset is [ 0 , 6 ] .$$

If fewer modulations order is needed for retransmissions the reserved indicators may be fewer. In a special case fewer values are used for retransmissions instead using a differential coding compared to the last explicitly signaled modulation order for the HARQ process and code word, e.g.
MCS_indicator=30: Modulation order Q_m=Q′_m, i.e. same modulation
MCS_indicator=31: Modulation order Q_m=Q′_m−2, i.e. lower modulation

Extending CQI table

This relates to Action 202 and 203 above. One possible extension of the CQI table is shown in Table 4.

TABLE 4
Extended CQI table.

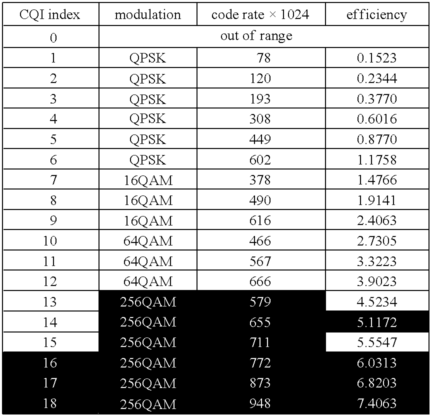

White entries correspond to legacy entries, where black entries are added or changed for 256QAM.

The CQI index table may be extended like Table 4. The user equipment 120 obtains a suitable CQI index from Table 4 and then obtains a CQI indicator based on the CQI index and the one and more offset values.

Please note that legacy use the term “index” both for the index in the table and what is signaled. In embodiments herein it is distinguished according to the following:

“index” corresponds to table entries

“indicator” corresponds to what is signaled.

The CQI index is obtained by the user equipment 120 measuring on downlink signal quality estimating a suitable efficiency to receive a downlink transmission with, that is highest efficiency that can be decoded with a 90% probability. The corresponding CQI index is achieved from Table 4. An. A CQI indicator is calculated based on CQI index and one or more offset values received from the network node,

CQI_indicator=CQI_index−CQI_offset

The CQI_indicator is included in a CSI report and sent on Physical Uplink Shared Channel (PUSCH) or Physical Uplink Control Channel (PUCCH) from the user equipment 120 to the network node. The network node 110 receives the CSI report including the CQI_indicator and calculates the CQI index as

CQI_index=CQI indicator+CQI_offset.

This CQI_index may be used by the network node 110 to select MCS_index for downlink transmission. It may also be used for other purposes such as scheduling decisions, downlink power control and others.

For legacy UE:s which the user equipment 120 may be, no offset is sent to the user equipment 120 and the legacy CQI table, Table 2, is used without any offset.

If CQI_offset=0 256 QAM may still indicated for the highest CQI_indicators that result in CQI_index 13-15. Alternatively CQI_offset=0 may indicate fall back to legacy CQI table and, 256 QAM becomes disabled and normal up-to Release 11 of 3GPP TS 36.213, Section 7.2.3 standard operation is obtained. Alternatively may a MCS_offset=0 indicate a fallback to legacy CQI table and a MCS_offset>0 may indicate that the new CQI table should be employed.

Since the reported CQI channel quality and desired code rate MCS follows each other the one or more offset values may be set commonly for MCS and CQI. A fixed factor CQIMCS_factor of for example 2 may be better applied to adjust for the difference in size and quality steps as:

CQI offset=MCS_offset/CQIMCS_factor

The CQIMCS_factor may also be configured for example signaled over RRC protocol or broadcasted in the system information from the network node to the UE.

Rank-Specific Offset

The transmission rank, the number of MIMO layers in spatial multiplexing transmission, of the channel has profound impact on the MCS operating point and CQI reporting level. When the rank is low, higher MCS and CQI values may be chosen than if the rank is high. This means that it may be beneficial that the one or more offset values, in this embodiment the respective values out of multiple offset values, is set individually per possible rank. This means that the user equipment 120 may obtain the MCS value, i.e. MCS as

MCS=MCS_indicator+MCS_offset(R),

where R is rank of the granted transmission and similarly for the CQI reporting where rank R is the Rank Indicator (RI) included in the CSI report.

For example, in LTE a Transport Block (TB) of size TBS is sent over air as encoded Code Word (CVV). LTE currently supports sending at most 2 CW, while the transmission rank (layers) is higher. For rank 2 and higher 2 CW are used, and LTE currently supports up to 8 layers. Since the MCS is selected individually for the up-to two code words, this suggests that in an alternative embodiment the respective offset value out of the multiple offset values, such as the MCS_offset value, is set individually per possible number of layers a TB may be carried over. For example, if rank 4 is supported then each TB may be sent on 1 or 2 layers and hence MCS_offset may have one value for transmitting a CW over 1 layer and another value for 2 layers.

Transmission Point Specific MCS Offset

This relates to Action 201 and 301 above. Support of higher order modulation is dependent on low Error Vector Magnitude (EVM) at the transmitter side, the EVM depends on factor such as output power. In some coordinated multi-point scenarios different output powers may be employed by different transmission points resulting in different EVM. A transmission point may be a eNodeB an RRU, a remote radio head, or an active Distributed Antenna System (DAS). It may hence be of interest to have separate off set values such as MCS_offset values dependent on the current transmission point. For example the MCS_offset may be different for different PDSCH Resource Element (RE) Mapping and Quasi-Co-Location Indicator” signaled in the DCI as defined in 3GPP TS 36.213 v11.3.0 section 7.1.9 and 7.1.10. Table 5 shows PDSCH RE Mapping and Quasi-Co-Location Indicator mapping to different MCS_offsets. The EVM is a measure used to quantify the performance of a digital radio transmitter or receiver. A signal sent by an ideal transmitter or received by a receiver would have all constellation points precisely at the ideal locations, however various imperfections in the implementation such as carrier leakage, low image rejection ratio, phase noise etc. cause the actual constellation points to deviate from the ideal locations. Informally, EVM is a measure of how far the points are from the ideal locations.

TABLE 5
PDSCH RE Mapping and Quasi-Co-Location Indicator
mapping to different MCS_offsets

| Value of ‘PDSCH RE Mapping and | |
|---|---|
| Quasi-Co-Location Indicator’ field | MCS |
| ‘00’ | MCS_indicator + MCS_offset(0) |
| ‘01’ | MCS_indicator + MCS_offset(1) |
| ‘10’ | MCS_indicator + MCS_offset(2) |
| ‘11’ | MCS_indicator + MCS_offset(3) |

Explicit MCS Subset Indication

In one embodiment of the invention a table like Table 2 is specified. A UE configured to use 256 QAM also receives an explicitly signaled subset of the table to use. The subset may have a fixed size of 28 entries if every modulation order is to be supported for retransmissions. The entries in the table may be signaled using a bit set or compressed by using combinatorial index r defined for example as:

$$r = {\sum }_{i = 0}^{M - 1} 〈 \begin{matrix}N - {s}_{i} \\ M - i\end{matrix} 〉$$

where the set {sᵢ}ᵢ₌₀^{M-1}, (1≦sᵢ23 N, sᵢ<sᵢ₊₁) contains the M sorted table indices and

$$〈 \begin{matrix}x \\ y\end{matrix} 〉 = \{ \begin{matrix}( \begin{matrix}x \\ y\end{matrix} ) & x \geq y \\ 0 & x < y\end{matrix}$$

is the extended binomial coefficient and N is the total size of the table, resulting in unique label

$$r ∈ \{ 0 , … , ( \begin{matrix}N \\ M\end{matrix} ) - 1 \}$$

For legacy user equipments and user equipments not configured for 256 QAM operation the first 29 entries in the table is used, i.e. same as up-to-R11 3GPP operation. Also a subset indication may be applied per rank or transmission point. It may be noted that this is a special case of signaling an offset value, where one offset is given per MCS indicator value.

Fallback Operation

To be able to robustly handle fast variation of channel quality and/or operation during periods of ambiguity in user equipment configuration, a fallback mode of operation may be required.

This relates to Action 201 and 302 above. In some embodiments, different offset values such as MCS_offset values or sub tables are used for different DCI formats. For example data scheduled using DCI format 1A/1C may apply the legacy MCS table operation, MCS_offset=0 and modulation order restriction to 6, while other DCI formats like format 1/2/2A/2B/2C/2D apply the configured MCS_offset or subset where the DCI format carry an indication of the allocated resource and the MCS indicator TS 36.212 V11.3.0 section 5.3.3.1.

In some embodiments different offset values such as MCS_offset values or sub tables are used dependent on the Radio Network Temporary Identity (RNTI) by with a DCI is scrambled. For example DCI may be scrambled by a Semi-Persistent Scheduling (SPS) Cell ©-RNTI, System Information (SI)-RNTI or Random Access (RA)-RNTI apply different offset values such as MCS_offset values or sub tables than DCIs scrambled by the C-RNTI.

In some embodiments different offset values such as MCS_offset values or sub tables are used dependent on the search space in with the DCI is received. For example a DCI received in a common search space apply a MCS_offset of 0 and modulation order restriction to 6, while a DCI received in the UE specific search space employ the configured MCS_offset. In some other embodiments different offset values such as MCS_offset values or sub tables may be used dependent on which EPDCCH-PRB set the DCI is received in. For an EPDCCH capable user equipment such as the user equipment 120, up to two EPDCCH-PRB sets may be configured, where each such set may include configuration of offset values such as MCS_offset values or sub tables.

Implicit Offset

This relates to Action 201 and 302. The preferred method to set the one or more offset values are by explicit signaling, for by example RRC signaling. However the one or more offset values may be defined implicitly from other radio quality measured which are correlated with MCS and CQI.

RSRP may be reported from the user equipment 120 to the network such as the network node 110. It is correlated with the desired MCS. At a low RSRP it is unlikely with a high CQI report and that it is desired to use a high MCS index. A table may be designed defining the offset out from latest reported RSRP.

Near the cell edge in dense networks the RSRP may be high and the desired MCS may still be low because of interference from neighbor cells. RSRQ may then be used which is also take the interference into account and is even more correlated with CQI and MCS. Similarly as for RSRP a table defining the one or more offset values from latest reported RSRQ may be used. Also combinations of RSRP and RSRQ may be used. For example a large offset is only set if both RSRP and RSRQ is high.

The history of used MCS or reported CQI may also be used. Protocol rules may be set so that if approaching the edge of the dynamic index range the one or more offset values are adjusted. For example if highest MCS_indicator is used the one or more offset values such as the MCS_offset value are increased with 1.

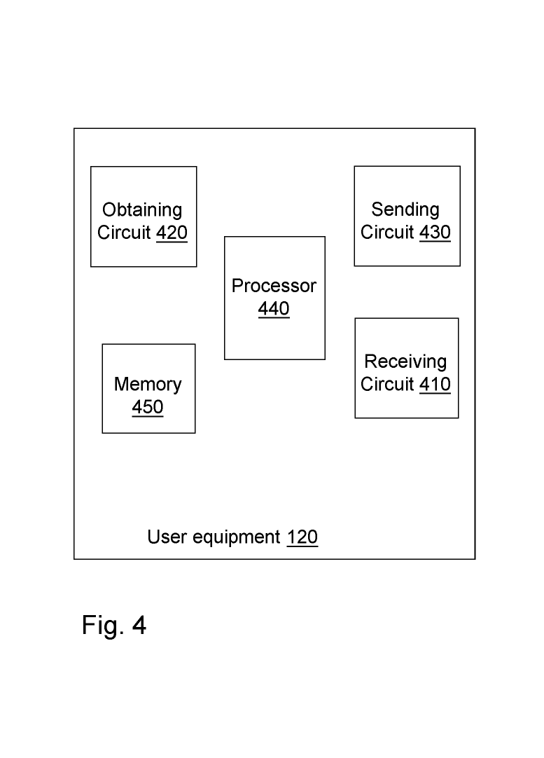

To perform the method actions for obtaining a MCS described above in relation to FIG. 2, the user equipment 120 comprises the following arrangement depicted in FIG. 4. As mentioned above the MCS is to be used for a transmission between the user equipment 120 and any one or more out of the network node 110 or the second network node 112. The user equipment 120 has knowledge about a modulation and coding index table.

The user equipment 120 comprises a receiving circuit 410 configured to receive one or more offset values from the network node 110.

The one or more offset values may be represented by one or more MCS subset selectors from the modulation and coding index table.

In some embodiments, the one or more offset values comprise multiple offset values. In these embodiments the respective offset value out of the multiple offset values may be associated with one or more out of: a rank, a quasi co-location, a downlink control information format, a Downlink control information resource, a user equipment search space sets for a Physical Downlink Control Channel, PDCCH, or evolved PDCCH, EPDCCH, and a transmission mode.

The one or more offset values may be represented by one or more MCS subset selectors from the modulation and coding index table.

The user equipment 120 further comprises an obtaining circuit 420 configured to obtain an MCS indicator.

The obtaining circuit 420 is further configured to obtain the MCS from the modulation and coding index table based on the MCS indicator and the one or more offset values.

The obtaining circuit 420 may further be configured to obtain a channel quality index from the modulation and coding index table, and obtain a channel quality indicator based on the obtained channel quality index and the one or more offset values.

In some embodiments, the obtaining circuit 420 further is configured to obtain the MSC indicator by receiving it from the network node involved in the transmission. The network node involved in the transmission is any one or more out of: the network node 110 or the second network node network node 112.

The user equipment 120 further comprises a sending circuit 430 which may be configured to report the obtained channel quality indicator to any one or more out of: the network node 110 or the second network node network node 112.

The embodiments herein for obtaining a MCS may be implemented through one or more processors, such as a processor 440 in the user equipment 120 depicted in FIG. 4, together with computer program code for performing the functions and actions of the embodiments herein. The program code mentioned above may also be provided as a computer program product, for instance in the form of a data carrier carrying computer program code for performing the embodiments herein when being loaded into the in user equipment 120. One such carrier may be in the form of a CD ROM disc. It is however feasible with other data carriers such as a memory stick. The computer program code may furthermore be provided as pure program code on a server and downloaded to the user equipment 120.

The user equipment 120 may further comprise a memory 450 comprising one or more memory units. The memory 450 is arranged to be used to store obtained information, measurements, data, configurations, schedulings, and applications to perform the methods herein when being executed in user equipment 120.

Those skilled in the art will also appreciate that the receiving circuit 410, the obtaining circuit 420 and the sending circuit 430 described above may refer to a combination of analog and digital circuits, and/or one or more processors configured with software and/or firmware, e.g. stored in the memory 450, that when executed by the one or more processors such as the processor 440 perform as described above. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

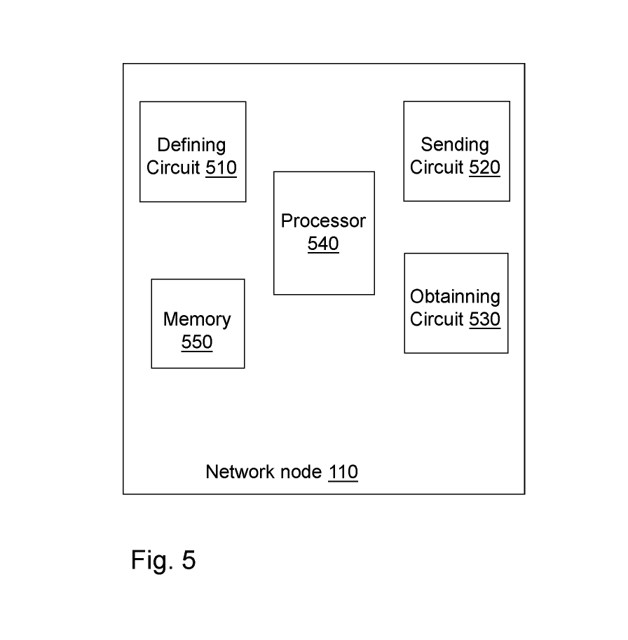

To perform the method actions for assisting a user equipment 120 to obtain a MCS described above in relation to FIG. 3, the network node 110 comprises the following arrangement depicted in FIG. 5. As mentioned above, the MCS is to be used for a transmission between the user equipment 120 and any one or more out of the network node 110 or a second network node 112.

The network node 110 comprises a defining circuit 510 configured to define one or more offset values for the user equipment 120. The defined one or more offset values are related to a modulation and coding index table.

In some embodiments, the defining circuit 510 further is configured to define one or more updated offset values for the user equipment 120 based on channel quality. The updated offset value is related to the modulation and coding index table.

The one or more offset values may be represented by one or more MCS subset selectors from the modulation and coding index table.

In some embodiments, the one or more offset values comprise multiple offset values. In these embodiments, the respective offset value out of the multiple offset values may be associated with one or more out of: a rank, a quasi co-location, a downlink control information format, a Downlink control information resource, a user equipment search space sets for a Physical Downlink Control Channel, PDCCH, or evolved PDCCH, ePDCCH, and a transmission mode.

In some embodiments, wherein the defining circuit 510 further is configured to define the one or more offset values for the user equipment 120 based on historical values from at least one out of: a transmitted MCS or rank, a received Channel Status Information, CSI, a Reference Signal Received Power, RSRP, or a Reference Signal Received Quality, RSRQ, and a Hybrid Automatic Repeat Request, HARQ, retransmission.

The network node 110 further comprises a sending circuit 520 configured to send the defined one or more offset values to the user equipment 120. The one or more offset values enable the user equipment 120 to obtain the MCS from the modulation and coding index table.

In some embodiments, the sending circuit 520 further is configured to send the defined one or more updated offset values to the user equipment 120. The one or more offset values enable the user equipment 120 to obtain an updated MCS from the modulation and coding index table.

In some embodiments, said transmission is arranged to be between the user equipment 120 and the network node 110. In these embodiments, the network node 110 may further comprise an obtaining circuit 530 configured to obtain an indication that data is to be transmitted in said transmission. In these embodiments, the sending circuit 520 may further be configured to send to the user equipment 120, an MCS indicator related to the transmission. The MCS indicator may be selected based on the one and more offset values and a CQI reported by the user equipment 120.

In some embodiments, the obtaining circuit (530) further is configured to receive a CSI report from the user equipment (120) which report comprises a CQI indicator, and obtain a CQI index into the CQI table from said CQI indicator together with the one or the offset values.

The embodiments herein for assisting a user equipment 120 to obtain a MCS may be implemented through one or more processors, such as a processor 540 in the network node 110 depicted in FIG. 5, together with computer program code for performing the functions and actions of the embodiments herein. The program code mentioned above may also be provided as a computer program product, for instance in the form of a data carrier carrying computer program code for performing the embodiments herein when being loaded into the in the the network node 110. One such carrier may be in the form of a CD ROM disc. It is however feasible with other data carriers such as a memory stick. The computer program code may furthermore be provided as pure program code on a server and downloaded to the the network node 110.

The network node 111 may further comprise a memory 550 comprising one or more memory units. The memory 450 is arranged to be used to store obtained information, measurements, data, configurations, schedulings, and applications to perform the methods herein when being executed in the the network node 110.

Those skilled in the art will also appreciate that the defining circuit 510, the sending circuit 520 and the obtaining circuit 530 described above may refer to a combination of analog and digital circuits, and/or one or more processors configured with software and/or firmware, e.g. stored in the memory 550, that when executed by the one or more processors such as the processor 540 perform as described above. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

According to some example embodiments herein, a method is provided for defining modulation and coding signaling protocol in a wireless communication network comprising a terminal and a network node. The method comprises:
a predefined modulation and coding index table,
a protocol indicator with smaller range than the table,
obtaining an offset, and
indexing the modulation and coding table with a combination of the offset and the protocol indicator.

In some embodiments the signaling protocol is the downlink scheduling DCI protocol and the indexing table is the MCS table.

In some embodiments the signaling protocol is the channel status quality indication reporting and the indexing table is the CQI table.

In some embodiments the offset is set per rank,

In some embodiments the offset is defined in the network node and signaled to the terminal with RRC protocol.

In some embodiments the offset is set based on latest signaled radio quality measures, one or more of RSRP, RSRQ, MCS or CQI.

When using the word “comprise” or “comprising” it shall be interpreted as non-limiting, i.e. meaning “consist at least of”.

The embodiments herein are not limited to the above described preferred embodiments. Various alternatives, modifications and equivalents may be used.

Therefore, the above embodiments should not be taken as limiting the scope of the invention, which is defined by the appending claims.

1-24. (canceled)

25. A method in a user equipment for obtaining a Modulation and Coding Scheme (MCS), which MCS is to be used for a transmission between the user equipment and any one or more of the network node and a second network node, which user equipment has knowledge about a modulation and coding index table, the method comprising:
receiving one or more offset values from the network node;
obtaining an MCS indicator related to said transmission;
obtaining the MCS from the modulation and coding index table, based on the MCS indicator and the one or more offset values.

26. The method of claim 25, wherein the one or more offset values are represented by one or more MCS subset selectors from the modulation and coding index table.

27. The method of claim 25, wherein the one or more offset values comprises multiple offset values, and wherein the respective offset value out of the multiple offset values are associated with one or more out of:
a rank;
a quasi co-location;
a downlink control information format;
a Downlink control information resource;
a user equipment search space sets for a Physical Downlink Control Channel (PDCCH) or evolved PDCCH (ePDCCH); and
a transmission mode.

28. A method of claim 25, further comprising:
obtaining a channel quality index from the modulation and coding index table, obtaining a channel quality indicator based on the obtained channel quality index and the one or more offset values, and reporting the obtained channel quality indicator to any one or more of the network node and the second network node.

29. A method of claim 25, wherein the MSC indicator is obtained by being received from the network node involved in the transmission, which network node involved in the transmission is any one or more of the network node and the second network node.

30. A method in a network node for assisting a user equipment to obtain a Modulation and Coding Scheme (MCS), which MCS is to be used for a transmission between the user equipment and any one or more of the network node and a second network node, the method comprising:
defining one or more offset values for the user equipment, which defined one or more offset values are related to a modulation and coding index table; and
sending the defined one or more offset values to the user equipment, which one or more offset values enables the user equipment to obtain the MCS from the modulation and coding index table.

31. The method of claim 30, wherein the one or more offset values are represented by one or more MCS subset selectors from the modulation and coding index table.

32. The method of claim 30, wherein the one or more offset values comprises multiple offset values, and wherein the respective offset value out of the multiple offset values are associated with one or more out of:
a rank;
a quasi co-location;
a downlink control information format;
a Downlink control information resource, comprising any one of: a user equipment search space for a Physical Downlink Control Channel (PDCCH) or evolved PDCCH (ePDCCH),and/or an evolved PDCCH-Physical Resource Block set (ePDCCH-PRB-set); a transmission mode; and an RNTI.

33. The method of claim 30, wherein said transmission is between the user equipment and the network node, the method further comprising:
obtaining an indication that data is to be transmitted in said transmission;
sending to the user equipment, an MCS indicator related to the transmission, which MCS indicator is selected based on the one and more offset values and a CQI reported by the user equipment.

34. The method of claim 30, further comprising:
defining one or more updated offset values for the user equipment based on channel quality, which updated offset value is related to the modulation and coding index table; and
sending the defined one or more updated offset values to the user equipment, which one or more offset values enables the user equipment to obtain an updated MCS from the modulation and coding index table.

35. The method of claim 30, wherein the defining the one or more offset values for the user equipment, is performed based on historical values from at least one of:
a transmitted MCS or rank;
a received Channel Status Information (CSI);
a Reference Signal Received Power (RSRP) or a Reference Signal Received Quality (RSRQ); and
a Hybrid Automatic Repeat Request (HARQ) retransmission.

36. The method of claim 30, further comprising:
receiving a CSI report from the user equipment which report comprises a CQI indicator; and
obtaining a CQI index into the CQI table from said CQI indicator together with the one or more offset values.

37. A user equipment for obtaining a Modulation and Coding Scheme (MCS), which MCS is to be used for a transmission between the user equipment and one or more of the network node and a second network node, which user equipment has knowledge about a modulation and coding index table, the user equipment comprising:
a receiving circuit configured to receive one or more offset values from the network node; and
a processing circuit configured to obtain an MCS indicator related to said transmission and to to obtain the MCS from the modulation and coding index table based on the MCS indicator and the one or more offset values.

38. The user equipment of claim 37, wherein the one or more offset values are represented by one or more MCS subset selectors from the modulation and coding index table.

39. The user equipment of claim 37, wherein the one or more offset values comprises multiple offset values, and wherein the respective offset value out of the multiple offset values are associated with one or more of:
a rank;
a quasi co-location;
a downlink control information format;
a Downlink control information resource;
a user equipment search space for a Physical Downlink Control Channel (PDCCH) or evolved PDCCH- Physical Resource Block (PRB)-set (ePDCCH-PRB-set); and
a transmission mode.

40. A user equipment of claim 37, wherein
the processing circuit is further configured to obtain a channel quality index from the modulation and coding index table, and obtain a channel quality indicator based on the obtained channel quality index and the one or more offset values; and
wherein the processing circuit is further configured to report the obtained channel quality indicator to any one or more of the network node or the second network node.

41. A user equipment of claim 37, wherein processing circuit further is configured to obtain the MSC indicator by receiving it from the network node involved in the transmission, which network node involved in the transmission is the network node or the second network node.

42. A network node for assisting a user equipment to obtain a Modulation and Coding Scheme (MCS), which MCS is to be used for a transmission between the user equipment and any one or more out of the network node or a second network node, the network node comprising:
a processing circuit configured to define one or more offset values for the user equipment, which defined one or more offset values are related to a modulation and coding index table; and
a sending circuit configured to send the defined one or more offset values to the user equipment, which one or more offset values enables the user equipment to obtain the MCS from the modulation and coding index table.

43. The network node of claim 42, wherein the one or more offset values are represented by one or more MCS subset selectors from the modulation and coding index table.

44. The network node of claim 42, wherein the one or more offset values comprises multiple offset values, and wherein the respective offset value out of the multiple offset values are associated with one or more of:
a rank;
a quasi co-location;
a downlink control information format;
a Downlink control information resource;
a user equipment search space sets for a Physical Downlink Control Channel (PDCCH) or evolved PDCCH (ePDCCH); and
a transmission mode.

45. The network node of claim 42, wherein said transmission is arranged to be between the user equipment and the network node, wherein:
the processing circuit is further configured to obtain an indication that data is to be transmitted in said transmission; and
the sending circuit further is configured to send, to the user equipment, an MCS indicator related to the transmission, which MCS indicator is selected by the processing circuit based on the one and more offset values and a CQI reported by the user equipment.

46. The network node of claim 42, wherein:
the processing circuit is further configured to define one or more updated offset values for the user equipment based on channel quality, which updated offset value is related to the modulation and coding index table, and wherein
the sending circuit is further configured to send the defined one or more updated offset values to the user equipment, which one or more offset values enables the user equipment to obtain an updated MCS from the modulation and coding index table.

47. The network node of claim 42, wherein the processing circuit further is configured to define the one or more offset values for the user equipment based on historical values from at least one of:
a transmitted MCS or rank;
a received Channel Status Information (CSI);
a Reference Signal Received Power (RSRP) or a Reference Signal Received Quality (RSRQ); and
a Hybrid Automatic Repeat Request (HARQ) retransmission.

48. The network node of claim 42, wherein the processing circuit further is configured to:
receive a CSI report from the user equipment which report comprises a CQI indicator; and
obtain a CQI index into the CQI table from said CQI indicator together with the one or more offset values.
